(19) United States
(12) Patent Application Publication
(10) Pub. No.: US 2026/0211907 A1
(43) Pub. Date: Jul. 23, 2026

(54) METHOD AND SYSTEM FOR THE GENERATION OF TWO-DIMENSIONAL GRAPHICAL MAPS OF OVERHEAD ELECTRICAL DISTRIBUTION GRIDS

(71) Applicant: ENEL GRIDS S.R.L., Roma (IT)

(72) Inventor: Mario Namtao Shianti Larcher, Mestre - Venezia (IT)

(73) Assignee: ENEL GRIDS S.R.L., Roma (IT)

(21) Appl. No.: 19/142,605

(22) PCT Filed: Dec. 12, 2023
(86) PCT No.: PCT/IB2023/062530

§ 371 Date: Jun. 23, 2025

(30) Foreign Application Priority Data
Dec. 21, 2022 (IT) 102022000026262

(51) Int. Cl. G06F 16/29; G01S 17/89; G06V 10/24; G06V 10/762; G06V 20/10; G06V 20/17

(52) U.S. Cl. CPC G06F 16/29; G01S 17/89; G06V 10/242; G06V 10/762; G06V 20/17; G06V 20/176

(57) ABSTRACT

Method and system for the generation of two-dimensional graphical maps of overhead electrical distribution grids. The method comprises the steps of providing at least a three-dimensional image of a territory wherein at least one segment of an electrical distribution grid is provided, which is made up of a three-dimensional image point cloud; classifying through the Point Cloud Segmentation algorithms the image of the cloud of three-dimensional points (cloud of Lidar points) identifying the different classes of constitutive elements of the electrical grid; dividing said image points uniquely associated to one of said different classes of grid constituent elements in sets of image points having the same classification category and representing the same constitutive element at least based on the classification category by identifying image points related to one or more supports and image points relating to one or more conductors; generating a representation of said at least one segment of the electric grid by means of a graph, in which graph, the sets of image points classified as representative of a supporting element are represented by the nodes of said graph and the sets of image points classified as conductors are represented by arcs that connect at least two nodes together; storing said representation and printing or viewing the same. The system comprises process hardware that runs software comprising the instructions to configure said hardware to perform the method steps.

The invention refers to a method and a system for generating two-dimensional graphical maps of overhead electrical distribution grids.

Monitoring of electrical distribution grids is a necessary activity for maintaining the optimal operating conditions of these grids. Carrying out these monitoring operations requires high costs and relatively long times if carried out in the traditional way. Often, physical and direct access to the grids and their constituent elements, such as poles or other things, is made difficult by the morphology of the installation sites which makes the aforementioned operations even more difficult, time-consuming and expensive.

Systems which involve using aerial shots of the grids have therefore been developed, which provide images from which information relating to the grid constituent elements portrayed in said images is extracted.

The most advanced systems mainly involve the use of human-guided aircraft, such as helicopters in particular and in some cases also of automatically or remotely guided aircraft, such as the so-called drones for the acquisition of images of the territory. These aircraft are equipped with optical image acquisition units. The filming generates a large amount of image and video data of the territory and requires processing of the image data in order to identify the elements that form the distribution grid, such as cables, poles, etc. their position in a map of the territory and any dimensional features that characterize the different grid constituent elements.

The analysis of image data is complex and when performed in a manual mode requires a long time so the efficiency of the grid mapping process for the subsequent monitoring of its operating conditions is extremely low not only from the point of view of execution, but also from the point of view of precision.

Currently, in order to overcome the problems relating to manual analysis of the acquired images, it is also known to use different types of machine learning algorithms to perform the processing and analysis operations of said images.

In the most recent systems, the acquisition of the morphological features of the territory and of the objects present on it, such as in particular electrical distribution grids, does not or does not solely occur through optical images, or photographs of the territory, but the features of the territory, that is, at least some specific areas of the same territory wherein said electrical distribution grids are present are carried out using so-called LIDAR or similar systems which are capable of acquiring three-dimensional reproductions of said areas of the territory, said reproductions being made up of so-called LIDAR point clouds. A general description of LIDAR technology is contained on the web page https://it.wikipedia.org/wiki/LIDAR and is to be considered integrated into this description as it is intrinsically contained in the acronym LIDAR.

The number of data relating to the features of the territory reproduced with LIDAR technology increases significantly compared to that of aerial photographs. In fact, by their nature LIDAR point clouds are three-dimensional reproductions of the morphology of the territory, while the images acquired through aerial photography are only two-dimensional images.

In the present description and in the claims, for simplicity, the points of the three-dimensional point cloud obtained by acquisition with LIDAR or similar technology will be simply referred to as image points for brevity.

In the process of monitoring and identifying anomalies, an essential step is the reconstruction of a map of the grid from the cloud of three-dimensional image points, said map made up of a two-dimensional projection of the three-dimensional images on the horizontal plane and said map comprising the map of the territory on which the essential elements that constitute the grid are superimposed in the correct positions relative to the map of the territory and which, by way of example and without limitation, are for instance:

Supports defined as anything that supports other electrical assets. Examples of supports are poles, cabins, pylons and other elements;

Conductors defined as any cable between two supports such as bare wire, helicord and other types of conductors.

At the state of the art, methods and systems are known which envisage identifying in the cloud of three-dimensional points relating to the images of a territory which have been acquired using technology called LIDAR or similar and wherein the cloud contains at least one grid segment, the points of the cloud of LIDAR points, hereinafter also defined for brevity as image points, said image points referring to elements of said electrical grid and classifying each image point as reproducing a specific element of said grid segment reproduced in the image point cloud, as well as separating from the point cloud said points of the cloud which represent said constituent elements of the grid segment. These well-known methods and systems involve an automated analysis process of the point cloud obtained from footage of the territory comprising a certain grid segment thanks to machine learning algorithms, such as classifiers and more in particular so-called point cloud segmentation algorithms, or similar (see for instance 3D point cloud segmentation: A survey, Anh Nguyen, Published in: 2013 6th IEEE Conference on Robotics, Automation and Mechatronics (RAM), 12-15 November 2013, 10.1109/RAM.2013.6758588, ISBN:978-1-4799-1198-1). The aforementioned process is also known as semantic segmentation and allows to limit the number of points of the cloud to be processed for the reconstruction of a map that represents the segment of the grid reproduced in the point cloud of the acquired image(s) and also for identifying among the points representing the segment of the reproduced grid which of said points refer to specific structural elements of said grid, such as for instance supports, poles, pylons, or the like and conductors, cables, or the like.

The identification and classification process is a well-known process which is carried out according to different methodologies. Examples of these methodologies are described, for instance, in documents US2021034027, U.S. Pat. No. 10,540,577.

The process of generating a reliable map of the grid segment reproduced in the three-dimensional image point cloud corresponding to the acquired three-dimensional image is also a complex process which requires specific steps to obtain acceptable precision in map reproduction of the grid constituent elements, comprising their relative position, optionally the dimensions of said elements as well as the position of these elements in the territory map.

With regards to the effective use of the data acquired for the purpose of monitoring activities, the precision of said map is essential. At the same time, given the considerable amount of data, it is also essential to be able to generate said maps in a simple, fast and nevertheless extremely reliable way as regards the correspondence with the real situation in the field of the information contained in the map and extracted from the three-dimensional point cloud of the acquired images.

The document Huang Bohao et Al: “Grid Tracer: automatic Mapping of Power Grids using Deep Learning and Overhead Imagery”, IEEE Journal Of Selected Topic in Applied Earth Observations and Remote Sensing, 2 Nov. 2021, pages 4956-4970, XP055884017, ISSN:1993-1404, DPOI:10.1109/JSTARS.2021.3124519 which can be acquired from the internet from the URL: https://arxiv.org/pdf/2101.06390.pdf describes a method which provides some of the steps of the preamble of main claim 1 except steps c) and d) and 2D image processing for grid pylons detection.

The document Zhang Ruizhuo et Al: “Automatic Extraction of High Voltage Power Transmissions Objects from UAV Lidar Point Clouds”, Remote Sensing,. Vol. 11, no. 22, 6 Nov. 2019, page 2600, XP055944269, DOI:10.33990/rs11222600 describes the extraction of 3D geo-information of high-voltage electrification lines, pylons and conductors.

The aim of the present invention is therefore to create a method for generating two-dimensional graphical maps of overhead electrical distribution grids which allows the limitations present in state-of-the-art methods to be overcome, obtaining the advantages described above.

The present invention therefore has as its object a method for generating two-dimensional graphical maps of overhead electrical distribution grids, said method involving the combination of steps of claim 1.

In one embodiment, the nodes representing the individual supporting elements and the arcs representing the conductors can be associated with additional attributes such as the position of one or more of the supporting elements represented by the nodes, either relative to the other supporting elements and/or absolute referring to the map of the territory and/or the vertices of a polygon of minimum area, in particular a quadrilateral, which contains all the image points of the set representing the same supporting element and/or the attributes indicating the number of conductors that are represented by an arc that connects two supporting elements together.

According to a further feature, which can be provided in any combination with one or more of the previous embodiments, the method according to the present invention may provide for a step of
a) verifying whether or not two supporting elements are connected to each other, said step comprising the counting of the image points of the set of image points classified as representative of a conductor corresponding to an arc that connects two nodes representative of two supporting elements and the comparison of the number of image points of the set of these representative image points of said conductor with a predetermined number of minimum image points, below which said two supporting elements are not considered connected to each other.

Still according a further feature, which can be provided in any combination with one or more of the previous embodiments and/or feature forms, said method provides for a step of
b) determining the number of cables that connect two supporting elements with each other which comprises the use of a clustering algorithm of the image points of the set of image points classified as representative of a conducting element along an arc connection of two nodes, i.e. two supporting elements, the number of clusters being defined as a number of cables.

According to an embodiment of the aforementioned method, steps b) and b) comprise:
filtering from the three-dimensional point cloud of the image points relating to a classification category other than that relating to the constitutive elements of the grid i.e. from the classification category relating to the supports and conductors;
eliminating the coordinate along the vertical axis (height) of each image point, bringing the image points on a two-dimensional horizontal plane;
clustering of the image points relating to each supporting element with a clustering algorithm,
calculating for each said image point cluster the centroid and being determined the vertex of the minimum rectangle that contains all the image points of said cluster,
the centroid of each image cluster defining the position of the corresponding node of the final graph and the vertex of the rectangle containing the image points of the corresponding image points cluster of the corresponding node defining an indicative measure of the area occupied by the corresponding supporting element, while
for each point image cluster relating to a supporting element, it is verified if this is connected to other image point clusters relating to other adjacent supports and if the existence of the connection is positive, in the final graph is added an arc between the two adjacent nodes that are connected, being settable a maximum distance from each node within which to determine the presence of at least one further node connected to it, said distance being optionally settable, being two nodes corresponding to two supporting elements considered not connected directly among them when among them there is an additional node corresponding to a further supporting element, being said two supporting elements considered connected through said further supporting elements and being provided for connecting arcs of the nodes representing said two supporting elements with the node representing the additional intermediate supporting element.

According to a further feature prior to the connection of the nodes to each other through the arcs of the graph, said nodes are ordered with the corresponding centroids and the corresponding vertices based on one of the coordinates of the two-dimensional reference plane for the graph and the two-dimensional territorial map, that is, a substantially horizontal plane, preferably relative to the X coordinate of a Cartesian reference system that subtends said plane.

According to yet another embodiment of the method, following the verification of the connection of a node to a further adjacent node, i.e. the image point cluster respectively corresponding to said nodes, the method optionally provides for eliminating the nodes that are not connected to further nodes of image point clusters classified in the supporting elements category.

Still according to a possible feature that can be provided in combination with one or more of the features and/or embodiments described previously, the method involves the further step of extracting the maximum spanning tree of the graph, giving each associated arc a weight inversely proportional to its length and favoring arcs between two adjacent nodes over other arcs that are eliminated or considered eliminable.

According to a further feature, the graph obtained from the previous steps is saved in the form of a digital file, for instance in the form of a JSON file format.

In relation to the clustering step of the image points relating to the same supporting element, the method can provide different clustering algorithms, and in a preferred embodiment the clustering algorithms are chosen among clustering algorithms which do not require defining a priori the number of clusters, such as the algorithms known as DBSCAN, HDBSCAN.

According to an embodiment, for the verification relating to whether or not two image point clusters representing two adjacent supporting elements are connected to each other or not, the method according to one or more of the previous embodiments and/or features may provide the following connection verification steps:
the calculation of a rotation matrix that makes the segment that makes horizontal the two centroids of the image point clusters each representing one of two supporting elements;
the rotation based on the rotation matrix calculated in the previous step of the image points and in particular of the centroids and vertices of the clusters of said image points which represent said supporting elements and furthermore the rotation of the image point clusters which belong to the classification category of at least one conductor present among said image point clusters representing said supporting elements,
the image points of the image point cluster that belong to the classification category of at least one conductor being filtered before and/or after the aforementioned steps so as to maintain only the image points present in a corridor defined by the vertices of the minimum rectangles relating to the image point clusters belonging to the category of supporting elements and relating to said two supporting elements;
the area defined by said corridor and between said two nodes representing said two supporting elements being divided into a plurality of blocks of fixed length, said length being optionally settable at will and for each block and
the number of image points present in the corresponding block and corresponding to the classification category relating to a conducting element being determined,
while said number of image points determined in a block is compared with a minimum number of image points having a classification category relating to a minimum conducting element, said minimum number being settable and considered as occupied by a segment of a conducting element when said number of image points determined in a corresponding block is greater than said minimum number, and
the two supporting elements relating to said two image point clusters having a classification category relating to the supporting elements being considered connected to each other by at least one conducting element when for a pre-established percentage higher than a certain settable threshold, the blocks of said plurality of blocks into which said corridor is divided are considered occupied, the number of image points corresponding to at least one conducting element in said blocks being higher than said minimum number, while when said percentage of said blocks considered occupied is lower than said settable threshold the two supporting elements are not considered connected to each other
in the first case there is an arc connecting the two nodes representing said two supporting elements, while in the second case said connecting arc is not present.

According to a feature of improvement of the steps described above, the method can further allow to set up a right margin and/or a left margin of said corridor which delimits an area of said corridor that is intermediate between said two supporting elements, namely among the containment rectangles of the relative image point clusters whose margins are spaced relative to said image point clusters to a pre-established extent in order to consider only the image points relating to at least one conducting element present only in said intermediate section of said corridor, not considering for the determination of the existence of the connection, the image points relating to said at least one conducting element that are relatively close to the image point clusters corresponding to the supporting elements corresponding to a predetermined position of said margins with respect to said image point clusters corresponding to the supporting elements of the poles.

With reference to a possible procedure for determining the number of conductors, i.e. cables, among the individual supporting elements, according to an embodiment of this invention which can be provided in any combination with one or more of the embodiments previously described and/or with one or more of the features previously described, the method provides for the following steps:
starting from the image points representative of at least one conducting element identified between the image point clusters relating to two supporting elements, the first and second main component are calculated with an algorithm of Principal Component Analysis (also called PCA);
the first component is used to eliminate by filtering the image points close to the image point clusters relating to said supporting elements, remaining only the representative image points of the conducting element(s) present in a central segment between the two image point clusters representative of the two supporting elements and said central segment being set by a settable length;
a clustering algorithm is then applied to the second main component of the remaining image points following the aforementioned filtering step, being the number of clusters provided by said clustering algorithm defined as the number of cables that connect said two supporting elements together.

Similarly to the provisions for the clusterization of the image points relating to the individual supporting elements, also in this case are preferred the clustering algorithms that do not require to define a priori the number of clusters, such as the aforementioned DBSCAN, HDBSCAN or other similar clustering algorithm.

As regards the a) step of this method according to the combination of more general steps indicated above, this acquisition step of 3D images can be performed using the systems available to the state of the art, for instance, through aerial shots that use one or more different techniques of acquiring images and specifically that use techniques of acquisition of three-dimensional images, that is, capable of generating three-dimensional clouds of the image points representative of the objects present in the shooting scene.

In order to obtain LIDAR image points, it is currently preferred to use human-led aircraft, such as helicopters or the like. The use of remote or automatic driving aircraft is in principle possible and considered, but from a practical and above all organizational and safety point of view it presents critical issues. Nonetheless, a particular embodiment which allows to obtain operational advantages above all from the point of view of costs consists in the use of drones, in particular of flying drones, or of so-called UAV (Unmanned Aerial Vehicle) techniques.

Documents CN107992067A or CN11268696A describe devices of this type.

As image acquisition technology for the generation of clouds of three-dimensional image points was preferable and advantageous an acquisition technology called LIDAR and known to the state of the art. However, this indication is not to be considered limiting, as the method according to the invention can be applied in combination with any image point cloud regardless of the acquisition method.

This also applies to the classification of the image points in order to identify the image points relating to the constitutive elements of the electrical distribution grid potentially present in the territory of which the three-dimensional image and their separation from the image points that do not refer to objects classifiable as constitutive elements of the electrical grid. Preferably such constitutive elements are essentially two as defined above and classified with the term supporting element and conducting element.

This classification step can be performed thanks to classification algorithms and/or even in combination with so-called point of point cloud segmentation algorithms as better specified in the introductory part of the present description. Examples of these classifications and segmentation of the image points relating to specific objects represented in the cloud of three-dimensional image points are described, for instance, in the US2021034027, U.S. Pat. No. 10,540,577 documents.

The present invention also has as its object a system for implementing the aforementioned method, said system comprising a generic image processing hardware, said hardware comprising at least one processor, at least one memory containing at least one images processing program, one or more data entry interfaces by the user manually or by means of reading device of data storage mediums and/or transmission via Wi-Fi or wired communication grid, at least one printing interface and/or display of data or information,

Said image processing program comprising the instructions codified to make the processor and the related generic peripherals enabled to perform automatically or on request by a user the steps of the method according to one or more of the above-described embodiments and features.

According to an embodiment, the system can be provided in the form of kit and provide in combination with the above system at least one autonomous device of acquisition of three-dimensional images of a predetermined scene and at least one integrated processor in said device or separated and communicating with said device, said processor performing a processing program of the images acquired in said scene, said program comprising the instructions to perform an algorithm for image point cloud generation, classification of said image points relating to one or more diversifying features of one or more objects reproduced in said image point cloud and filtering of the image points relating to attributes or categories of classifications that do not correspond to one or more specific classification attributes selectable by the user.

According to yet another feature, the invention refers to a computer program which comprises instructions for carrying out one or more or all the steps of the method according to one or more of the embodiments and/or features described above, said program being stored on a fixed or portable storage medium and readable by a generic computer equipped with a corresponding reading device for said medium.

Still according to a further aspect, the present invention refers to a fixed or portable storage medium wherein a computer program is stored which comprises the instructions for carrying out one or more or all the steps of the method according to one or more of the embodiments and/or the features described above.

The invention presents further features which are the object of the dependent claims.

The features of the invention and the advantages deriving from it will be better understood from the following description of a non-limiting embodiment illustrated in the attached drawings wherein:

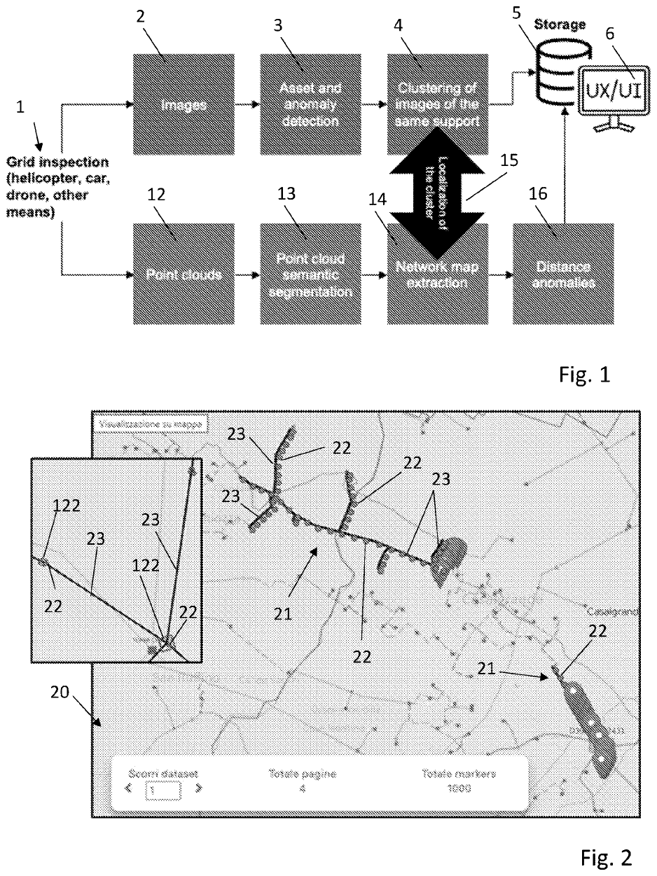

FIG. 1 shows a high-level block diagram of an example of a system for monitoring electrical distribution grids wherein a step of generating a two-dimensional map of the grid is provided.

FIG. 2 shows an example of a two-dimensional map of the grid obtained according to the method and with a system according to an embodiment of the present invention, said two-dimensional map of the electrical grid being superimposed in register with a two-dimensional map of the territory wherein said electrical grid is present.

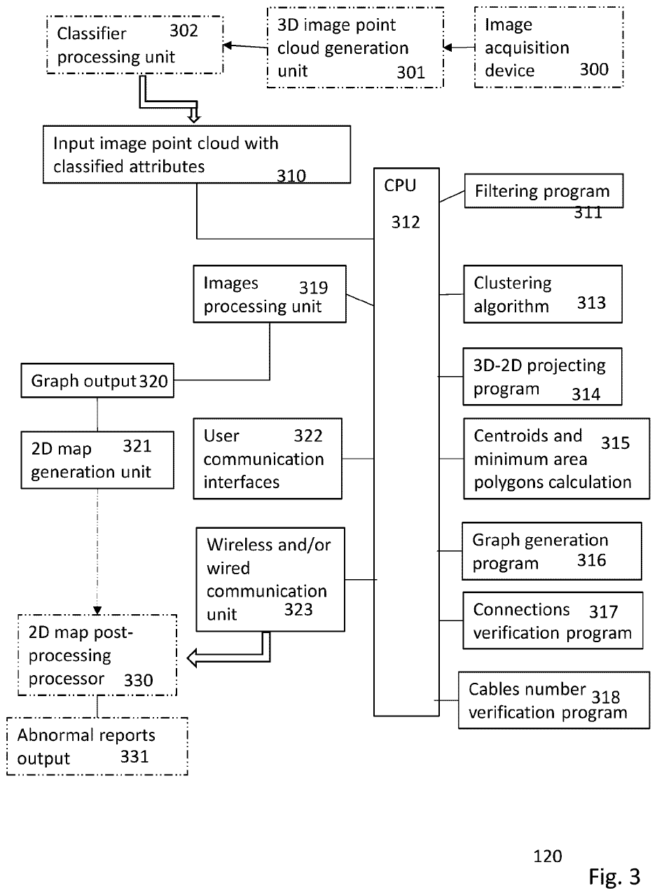

FIG. 3 shows a high-level block diagram of an embodiment of a system for generating two-dimensional maps of an electrical grid with the method according to the present invention.

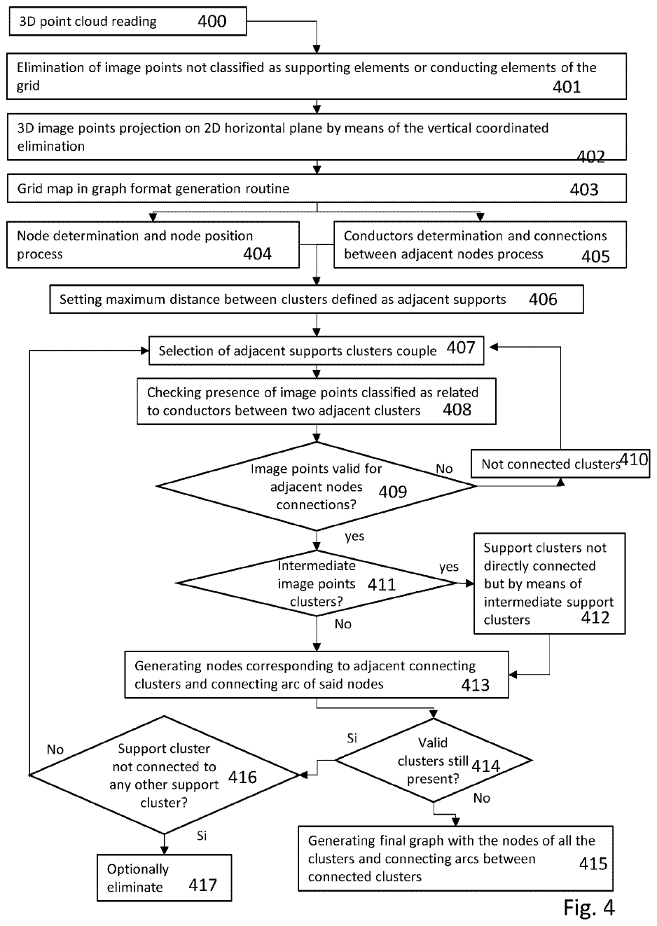

FIG. 4 is a high-level flowchart of an embodiment of the method according to the present invention.

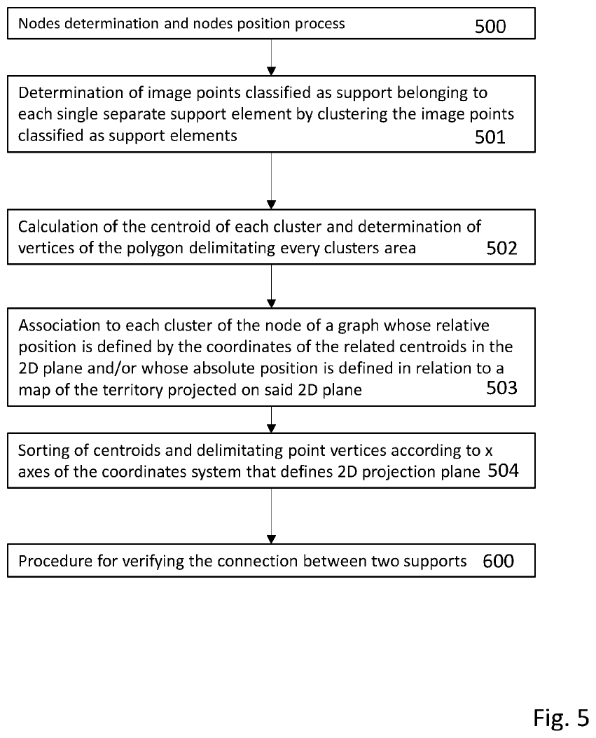

FIG. 5 is a flowchart of an embodiment of the steps for the process of determining the nodes and the position of the nodes representing image point clusters classified as relating to expected supporting elements in the grid.

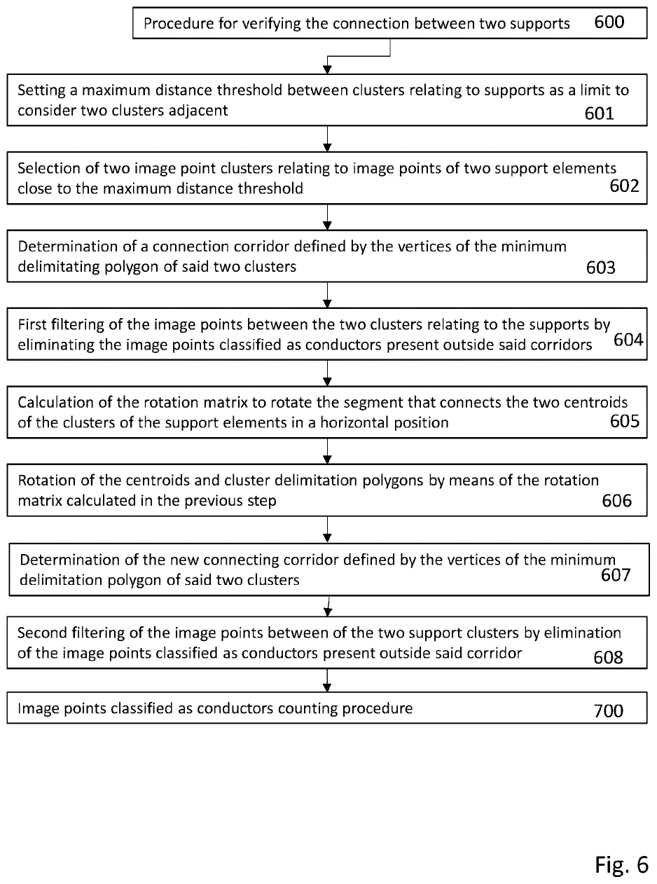

FIG. 6 is a flowchart of an embodiment relating to the steps of determining the existence of a connection between at least two clusters of image points classified as belonging to two different supporting elements of the grid.

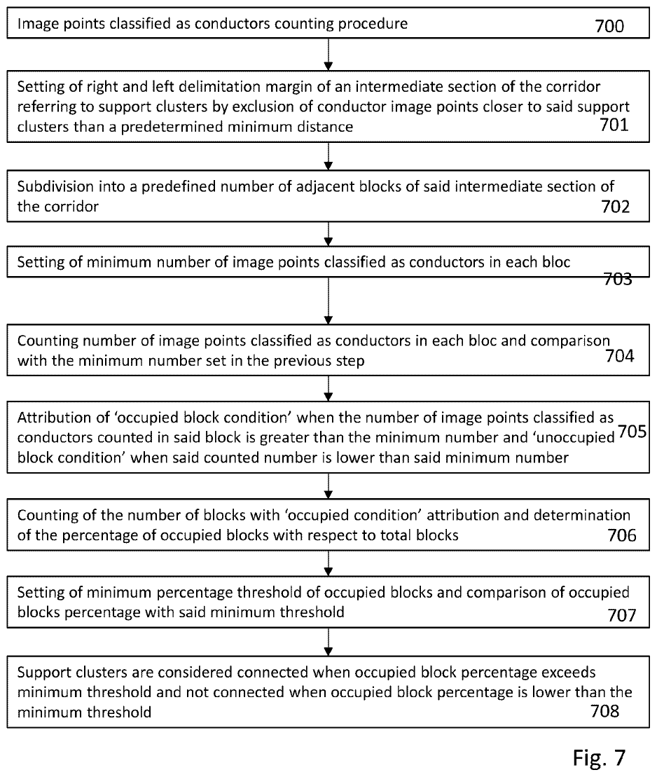

FIG. 7 is a flowchart of an embodiment of a procedure for counting image points classified as grid conductors.

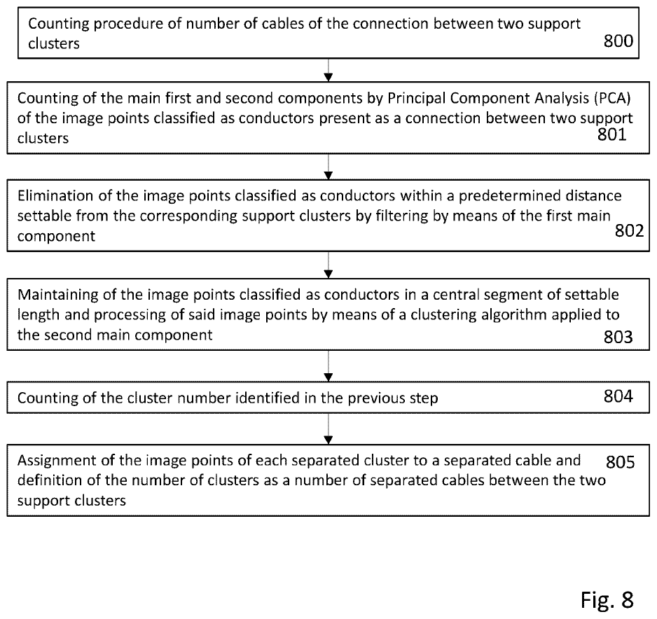

FIG. 8 is a flowchart of an embodiment of the procedure for determining the number of cables connecting two supporting elements.

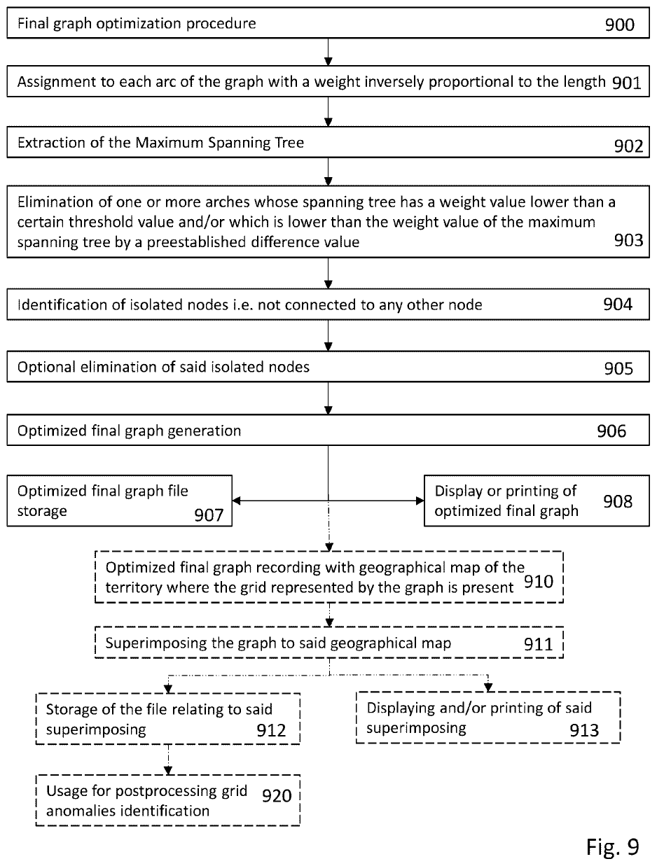

FIG. 9 shows a flowchart of a graph optimization procedure representing the two-dimensional map of the electrical grid and of further potential post processing steps of said graph.

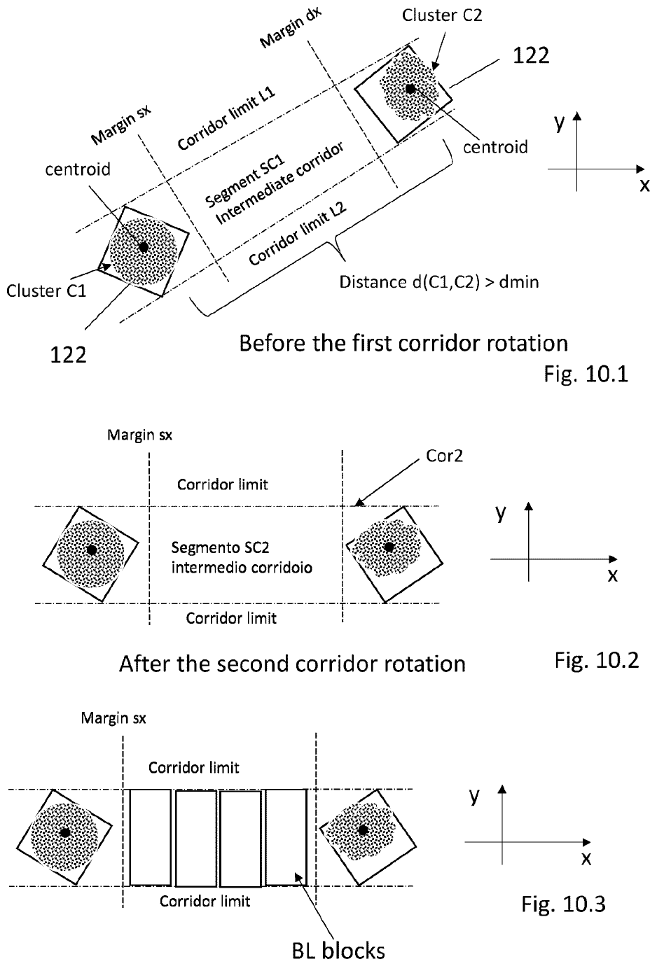

FIGS. 10.1, 10.2 and 10.3 show in a very schematic and approximate way the steps of the procedure for verifying the existence of a connection between two supporting elements.

In the present description and in the claims, the term classification category or classification attribute indicate a specific class to which an object represented by image points of an image point cloud belongs. In particular, specifically the category and/or attribute is related to the type of constituent element of an electrical distribution grid. In particular, a preferred but non-limiting embodiment of the present invention provides two classification categories i.e. two classification attributes which are respectively related to the conductor supporting elements and to the conductors in whatever configuration and shape they are present.

Furthermore, the term “classified as” refers to whether or not a certain attribute or category has been associated with an image point.

The terms conducting element and conductor are to be considered equivalent as are the terms support and supporting element.

With reference to the applications using the two-dimensional maps of the grid generated with the method and system of the present invention, what is stated in the present description is not to be considered limiting but constitutes a concrete example of the fact that the maps generated are not just a pure graphical representation of a scene, but they have a concrete and practical technical function.

FIG. 1 shows a high-level block diagram of a system for monitoring electrical distribution grids by processing images and image point clouds of a certain part of the territory wherein an electrical grid is provided and wherein said images are acquired by any means and image acquisition technique as indicated generically with 1 and as also explicitly indicated by the alternatives of aerial acquisition devices such as helicopters, and/or drones or other devices or also by devices consisting of land vehicles such as cars or other devices.

The system provides two parallel processing modes of the acquired image data which can be used for instance when the acquisition device uses two different image acquisition technologies, for instance acquisition of optical and photographic images and in parallel acquisition of three-dimensional images such as those which can be acquired using so-called LIDAR systems.

The acquired optical or photographic images are indicated with 2 and are processed for the identification of assets and grid anomalies, as indicated in step 3. Subsequently to step 4 the images are further processed to perform a clustering of the image data, for instance of the pixels of an image relating to the same object present in the scene whose image was acquired, in this case for instance of a supporting element.

The thus identified clusters can be stored in a database in a memory 5 of a storage system and can be recalled from said memory for display and/or further processing as indicated in a generic manner by the video terminals 6.

The second processing channel provides for the acquisition of three-dimensional images of the same scene in order to generate a three-dimensional image point cloud indicated with 12. In step 13 said image points are subjected to classification in order to associate each point with a specific attribute or belonging to a category. In the present description and in the preferred embodiment of the present invention the classification categories and/or attributes have been limited to three, that is to the classification of image points as representative of a supporting element of the electrical grid, such as poles, pylons or other and alternatively as representing a conducting element which is supported by said supporting elements. The third category is that relating to image points that do not fall into the aforementioned classification categories. The classification step which can be performed for instance with any classification algorithm, such as, for instance, a neural network or a combination of neural networks or other algorithms, is combined with a segmentation step which separates from each other the points of the point cloud which are associated with the various classification categories and which allows to filter the point cloud in order to eliminate the points that do not correspond to the categories of interest, i.e. in this example the categories relating to the supporting elements and the conducting elements.

The information obtained from the classification and segmentation process referred to in point 13 can be combined in a localization step, indicated with 15, of the clusters defined in step 4 which group within them the image data relating to the same supporting element.

Such a localization may be limited to a determination of the relative positions of the various clusters of image data of the relevant points of the point cloud, or even to a determination of the positions of these clusters of image data and points of the point cloud relative to a two-dimensional map of the territory wherefrom the images and the three-dimensional point cloud were acquired. From the combination of these data thanks to the method of the present invention it is possible to extract the maps of the grid in a two-dimensional representation, i.e. projected onto a horizontal plane, whose further processing allows to determine the presence or absence of anomalies relating to the conductors, such as for instance the calculation of the distances of the conductors from the vegetation, which anomalies in turn can be stored in the memory 5 and recalled for viewing and/or post-processing by the device 6.

FIG. 2 shows the result of the method according to the present invention for the extraction or generation of two-dimensional maps of an electrical distribution grid, or of a segment or a sector of the same which is present on a certain area of territory and said maps of the electrical grid being made up of a graph. 20 indicates a two-dimensional map of the territory, i.e. a projection onto a two-dimensional plane such as a substantially horizontal plane. Such an approximation is admissible even if the earth's surface is spherical since the bending radius is such that for sectors of the curved surface that are small with reference to the bending radius the difference between the horizontal plane and the curved surface coinciding with said plane is in practice negligible.

Referring to the definition of horizontal plane, this term is used to synthetically define a surface tangent to the spherical one or secant with respect to the spherical one and perpendicular to a radius of said spherical surface. The definition of the vertical direction is therefore referred to said horizontal plane and is parallel to said radius and perpendicular to said horizontal surface. Locally, therefore, the image of the scene reproduced in the three-dimensional point cloud can be defined in relation to a Cartesian reference system comprising the three axes perpendicular to each other, two of which are contained in said horizontal plane and a third oriented perpendicularly to said first two axes.

In the map 20 with 21 it is illustrated the degree of representation of the electrical grid, which is made up of a plurality of nodes indicated with 22, said nodes 22 being connected to at least one further node by means of arcs 23.

The lateral zoom on the left of FIG. 2 shows an enlarged detail of the map wherein a further feature of the graph is visible, wherein, as will be described in greater detail later, each node corresponding to an image point cluster of the image point cloud in which cluster said image points are representative of the same supporting element defined relative to the position of the node itself by the centroid of the point cluster, while as indicated with 122, the points of each cluster are delimited by a frame made up of a polygon, in particular and preferably a quadrilateral having the minimum possible area with reference to the area occupied by the point cluster.

FIG. 3 shows a hardware/software system for generating two-dimensional maps of the electrical grid from a three-dimensional image point cloud according to one or more of the embodiments of the method described below with reference to the remaining figures.

In FIG. 3, the hardware/software units that do not perform steps directly foreseen in the method of the present invention are indicated with blocks delimited by discontinuous lines.

In particular, and as already described with reference to FIG. 1, the present method consists in the processing of a cloud of three-dimensional image points wherein the image points of said cloud have already been previously subjected to the steps of semantic segmentation, i.e. the steps of classification of each image point as belonging to or representing a certain category of objects, i.e. constituent elements of the electrical grid. These classification categories are related, as indicated above and according to the preferred embodiment, to the supporting elements and conducting elements that make up the electrical grid.

The method of the present invention can operate on clouds of images acquired at different times and with different systems operating according to at least one acquisition technique. Therefore, in FIG. 3, the image acquisition device, preferably, for instance a LIDAR system, is indicated with 300 and with a box with discontinuous lines to clarify that said device is not necessarily part of the method and system according to the present invention even if said device can be provided in combination with the system according to the present invention, as also the acquisition step can be part of the combination of steps of the method according to the present invention.

Similarly, the cloud generation step indicated with 301 and the semantic segmentation step described above and indicated with 302 are also not necessarily part of the method and system of the present invention but could optionally be provided in combination.

310 indicates the step of entering the new image points into the system according to the present invention, wherein the image points have already been subjected to classification, i.e. semantic segmentation. A CPU 312, for instance a generic processor, is connected to one or more memories or to one or more memory areas, wherein are stored and can be recalled point cloud processing software wherein are codified the instructions for making the CPU 312 and any peripherals capable of carrying out the point cloud processing steps according to the method of the present invention and in particular according to one or more of the provided embodiments.

As will also appear from the subsequent detailed description of the workflows of the various processing routines, with 311 is indicated a memory wherein it is stored and from which can be recalled for the execution a filtering program of the point cloud 311, said program containing the instructions for the processor 312 that allow it to separate from the point cloud by filtering and maintain for the subsequent processing only the image points classified as relating to the supporting elements and the conducting elements that form the electrical grid reproduced in the point cloud. The remaining points are therefore left out and not subjected to further processing thus allowing to limit the amount of data to be processed.

Memory 313 contains and from the same can be recalled for the execution at least a clustering algorithm or a plurality of different clustering algorithms that can be used alternately or in combination with each other and whose application on the image filtered points and relating to the two classification categories allows generating sets of said image points, i.e. image point clusters that comprise representative image points of the same constitutive element of the electrical grid and with reference to the preferred example of the same supporting element and/or the same conductor or, as it will be described below, the same cable.

It is possible to use different types of clustering algorithms and preferably said algorithms are chosen from the clustering algorithms that do not require to define the number of clusters a priori. Possible examples of these clustering algorithms are known with the DBSCAN or HDBSCAN names or other similar algorithms.

Therefore, following the recall from the memory 313 of said clustering algorithm and the execution of the same by the CPU 312 on the remaining image points after the filtering, all the image points that represent the same support element and/or the same conductor and/or the same cable are grouped in a single and separate cluster, thus being generated a separate cluster for each supporting element and/or for each conducting element and/or for each cable.

FIG. 3, with CPU 312, it is generally indicated only one CPU or a plurality, that is two or more CPUs and/or even GPU operating in parallel with each other.

In memory 314 a software for the projection of the cloud of three-dimensional points on a two-dimensional plane is stored, for instance on the horizontal plane of the above defined two-dimensional geographical map. The CPU 312 recalling and performing such a program operates according to an embodiment a simple elimination of the space coordinate along an axis perpendicular to said two-dimensional projection plane, moving all the image points on said plane.

Further programs are contained in memories 315, 316, 317 and 318 and comprise instructions to make CPU 312 capable of carrying out the processing steps of the image points and/or clusters for the determination of the centroids of said points clusters relating to individual supporting elements and for the determination of the polygon, in particular of the quadrilaterals of the minimum area of containment of the image points of said clusters as shown in FIG. 2 and indicated with 122.

With 317 and 318 are indicated the memories or the memory areas wherein are stored the programs comprising the instructions for the verification of the connections between the various image point clusters representing the individual supporting elements, i.e. for the determination of the arcs of the graph and for the determination of the number of cables that constitute said connections. With 316 is indicated the memory area or the memory wherein the graph generation program is stored, which comprises a node for each point cluster relating to the same supporting element and an arc for each connection between nodes and representing a conducting element.

The number of cables present for a connection, as well as the maximum in plan size of each supporting element associated with a node are shown as an additional attribute that is indicated for instance in an alphanumeric way near the arcs or which is indicated by the perimeter of the polygon that contains the image points of the cluster corresponding to a node and a supporting element.

CPU 312 may not directly perform all or part of the software described above but can control and manage an image processing unit 319 specially provided for the execution of at least one part or all the software described above under the CPU 312 control. As indicated with 322 and with 323, CPU 312 can also control one or more communication interfaces with the user which can be of different types and can be provided alternately with each other or in combination, such as, for instance, keyboards, mouse, touchpad or similar pointing devices, other data and controls devices such as devices operating through the recognition of gestures and/or through voice commands, or the like. Alternatively, one or more of said devices can consist of a touchscreen type display device which in this case can also operate as a graph and other data output device to the user and can be provided alternately or in combination with other types of monitors and/or printing devices or similar.

The communication unit 232 can operate according to one or more communication and/or wireless communication protocols and the type used in grid communications, for instance as TCP protocols, or in communication systems with protocols called short range, such as for instance Bluetooth, Wi-Fi, NFC or others similar.

The processing unit provides as output a graph that forms the two-dimensional image of the grid part in the area of the territory under scan. This graph can be combined with an area map, as shown in FIG. 2 by means of a 2D map generation unit indicated with 321.

As indicated with the 330 and 331 blocks, it is possible to provide the 2D map out of the unit 321 or optionally also the graph as output of section 320 to perform a post-processing by means of a post-processing process, for instance in order to determine anomalies of the grid and possibly create reports of these anomalies, as indicated with 331, which are transmitted to the competent staff.

Also in this case, the post-processing processor 330 and reporting means 331 are not necessarily part of the system and/or the steps performed by them are not necessarily provided in combination with the steps of the present invention, but however they can be provided in combination with these, and this is highlighted by the discontinuous contour of the related boxes.

FIG. 4 shows a workflow of the main steps of the method according to this invention that can be performed with a system according to the embodiment of FIG. 3 or the like.

The process of generation of the two-dimensional maps of the electrical grid begins in this embodiment with step 400 of reading the point cloud where the image points are already classified in points that represent supporting elements, points that represent conducting elements and points that do not represent any of these categories of constitutive elements of the electrical grid.

Said points are subjected in step 401 to a filtering for the elimination from the point cloud of the image points that have not been classified as supporting elements or as conducting elements. In step 402, the remaining cloud points and therefore relating to the supporting elements and the conducting elements are projected on a two-dimensional horizontal plane, for instance, the plane underlying two coordinates of a three-dimensional coordinate system i.e. a horizontal plane according to one or more of the definitions made above. This takes place in this example by eliminating the position coordinates relating to the vertical axis, that is, the axis perpendicular to said plane.

Once finished the preparation of the point cloud, the procedure of generation of the grid is started by means of a graph as indicated with 403.

The workflow provides two processes that can also be performed in parallel as indicated in the figure or alternatively these processes may also be performed one after the other or interrelatedly.

This is the process of determining the nodes and position of the nodes indicated in box 404 and the process of determining the conductors and the connections between adjacent nodes indicated in 405.

In step 406 a maximum distance is set between two image point clusters that represent two supporting elements close to each other. Said two point clusters are considered close if their distance is not greater than said maximum distance, while when the distance of the clusters is higher than said maximum distance the two clusters are not considered to be close clusters and therefore said pair of clusters is not selectable for the steps of determining the existence of the connections between them.

At least two clusters are therefore chosen in step 407 that can be considered close to the maximum distance value defined in step 406 and in step 408 is performed a verification of the presence between said two image point clusters relating to the supporting elements and considered among them close to image points classified as relating to one or more conducting elements.

These image points are analyzed in relation to whether they are valid in order to represent a conductor element connecting said two point clusters representing two supporting elements close to each other. As indicated in step 409, when this verification is negative, said two image point clusters relating to said adjacent supporting elements are not considered connected as indicated with 410 and the process repeats the selection step of the two adjacent clusters indicated with 407.

When the image points detected between the two point clusters referring to the two adjacent supporting elements can be considered valid, the process continues with step 411 wherein it is determined whether between said two point clusters relating to said two adjacent supporting elements there is an additional intermediate cluster which represents a supporting element placed between said two adjacent supporting elements. If so, said two clusters relating to the two adjacent supporting elements are not considered directly connected to each other, but connected by means of the intermediate support as indicated with 412.

If the answer to the question of step 411 is negative, graph nodes are generated corresponding to the clusters that represent said two supporting elements selected in step 407 and the connecting arc of said nodes corresponding to a conducting element that connects one another said two supporting elements indicated in step 413.

If further point clusters are still provided in the point cloud that represent one or more further supporting elements, as indicated with step 414, the process moves on to step 416 to verify if there is at least one point cluster relating to a supporting element for which it is not possible to determine any connection with at least one further cluster. If a cluster of this type were identified, said cluster can be optionally eliminated as indicated in step 417, while for the remaining clusters for which there is a connection with other clusters the steps 407 to 416 are repeated and optionally also step 417. If there are no further point clusters relating to further supporting elements from step 414, move to step 415 to generate the final graph wherein all the image point clusters relating to supporting elements are represented by nodes having a predetermined position in the two-dimensional plane and being connected to each other by arcs representing conductor elements supported by said supporting elements.

FIGS. 5 and 6 show an example of a detailed workflow of the steps for the determination of the graph nodes that represent supporting elements and the position of these nodes on the two-dimensional map i.e. in the two-dimensional projection plane.

The process begins in step 500. In step 501, the image points classified as supports belonging to each individual supporting element are determined and separated through clustering of the image points classified as belonging to the supporting element category.

Each cluster comprises a plurality of image points distributed in a two-dimensional area and the position of the cluster in the projection plane of the two-dimensional map is calculated by the position of the centroid of the cluster, while the extension of the supporting element represented by each point cluster belonging to the same supporting element is determined by the vertices of a polygon, preferably a quadrilateral having the minimum dimensions wherein, however, are contained the points of said cluster inside the vertices as indicated in step 502.

The following step 503 provides that a node of a graph is associated with each cluster whose relative position is defined by the coordinates of the related centroids on the 2D and/or whose absolute position is defined in relation to a map of the territory projected on said 2D plane, i.e. said two-dimensional plane.

After step 504, the centroids and vertices of the cluster delimitation polygons are ordered with each other with reference to one of the position coordinates relating to one of the axes of the Cartesian reference system that underlies the horizontal plane, i.e. the projection plane.

Subsequently, a procedure for verifying the connection between two supporting elements as indicated by step 600 is performed.

An example of this procedure is illustrated with the flowchart of FIG. 6.

In step 601 the setting of a maximum distance threshold between point clusters relating to the supporting elements is performed and it constitutes a limit to consider two point clusters and therefore two supporting elements, i.e. two nodes that represent the same, adjacent between them.

The selection of two image point clusters relating to the image points of two supporting elements close to the maximum distance threshold of the previous step 601 is performed in step 602 while at the next step 603 the limits of a connecting corridor of said two point clusters relating to said adjacent supporting elements are determined, said corridor being defined by the vertices of the containment polygon of the points of said two clusters. A first filtering 604 of the image points present between said two clusters corresponding to the adjacent supporting elements involves the elimination of the image points present between said two point clusters and which are positioned outside the limits of said corridor.

For the remaining image points, the rotation matrix is calculated to rotate the segment that connects the two centroids of the clusters of the supporting elements as indicated in step 650 in a horizontal position, while said rotation of the centroid and the polygons of delimitation of the clusters by applying the rotation matrix calculated in the previous step is performed in step 606.

A new corridor connecting the clusters rotated in the previous step is determined in step 607, the position of the limits of said corridor being defined by the vertices of the containment polygons of the points of the point clusters subjected to rotation in step 606.

A second filtering step 608 follows which is performed similarly to the previous one i.e. in step 604, but with reference to the second corridor defined in step 607 after the rotation.

The next step 700 provides for the start of the classified image counting procedure as relating to conductor elements.

FIG. 7 shows a detail of a workflow of an embodiment of this procedure.

The setting of a right and a left delimitation margin of an intermediate section of the corridor defined in step 607 compared to the two point clusters relating to said two supporting elements is performed in step 701. These margins allow to exclude image points classified as relating to conducting elements that are closer to said point clusters that represent the two supporting elements compared to a predetermined minimum distance defined by the position of said margins. The subsequent process steps will therefore be performed with reference to the only said intermediate section of the corridor defined in step 607 and delimited at the two ends close to the clusters that represent the supporting elements by said margins.

Step 702 provides that said intermediate section of the corridor is divided into a plurality of pre-established length blocks and preferably adjacent to each other.

For each block or for all blocks, a minimum number of image points is set that codify a conductor element as indicated with 703. Subsequently, the image points present in each block are counted and they are classified as relating to a conducting element as indicated with 704, while in step 705 this number of image points present in each block is compared with the corresponding minimum number preset in step 703.

As indicated in step 705, when the number of image points counted in a block is higher than or equal to said minimum number, to said block is attributed the occupied block condition, while when the number of image points counted in a block is less than said minimum number, to said block is attributed the unoccupied block condition.

The count of occupied and unoccupied blocks is then carried out in 706 and the percentage of said occupied blocks is determined and said percentage is compared in step 707 with a minimum threshold of said percentage set in step 707.

As indicated in Step 708, two point clusters representing two adjacent supporting elements, i.e. two adjacent nodes, are considered to be connected to each other when said comparison in step 707 shows that the percentage of occupied blocks detected is greater than or possibly equal to the minimum threshold, while when said percentage is lower than said minimum threshold, the two point clusters representing two adjacent supporting elements, i.e. two adjacent nodes, are considered unconnected to each other.

If the presence of a connection is positively verified, this is represented in the graph by an arc that connects together the two nodes that represent the two supporting elements adjacent to each other.

With reference to the FIGS. 10.1, 10.2 and 10.3, these show schematically and summarize the steps described above in detail for the verification of the fact that two nodes that represent two supporting elements are connected directly to each other or not.

FIG. 10.1 shows the point clusters C1 and C2 relating to two nodes, that is, representative of two supporting elements. With 122 is indicated the minimum area polygon (in particular a rectangle), which inscribes the corresponding clusters C1, C2. The darker point in the corresponding clusters C1, C2 represents the centroid of said cluster.

The two clusters and the minimum area rectangles 122 are positioned in the two-dimensional projection plane of the three-dimensional point cloud in the initial relative positions obtained from said projections. Distance d (C1, C2) is defined with reference to a minimum distance, that is, it must be greater than this minimum distance. A corridor delimited by two ideal lines L1 and L2 defines a band between the two nodes or the two minimum area polygons 122. Laterally adjacent to a predetermined distance from the corresponding minimum area polygon 122 are defined respectively two ideal delimitation lines of the corridor called sx and dx margin and which define a central segment SC1 of said corridor Cor1. FIG. 10.1 shows the definition of the first corridor, before the rotation in x of the same and the definition of the second corridor Cor2 and the intermediate segment SC2 of the same in FIG. 10.2 and which is determined with steps similar to those of the determination of the first corridor and the relative segment intermediate as shown.

FIG. 10.3 shows the division of the intermediate segment SC2 into individual BL blocks.

According to what has already been exposed above, the processing of the image points can also provide indications on the number of cables that connect two supporting elements and therefore constitute a connection element between two adjacent supporting elements.

FIG. 8 shows an embodiment of a procedure for determining the number of cables that connect two supporting elements between them.

In step 800, the procedure is given. This provides for step 801 to calculate the first and second main components by executing an algorithm of Principal Component Analysis (PCA) on the image points classified as conductors and present as a connection between two point clusters representing two supporting elements connected to each other.

Step 802 provides for the elimination of the image points classified as a conductor within a predetermined distance from the corresponding point clusters relating to the supporting elements. Said pre-established distance can be set as you like. The filtering takes place by means of the first main component calculated in the previous step.

The next step 803 is expected to maintain the image points classified as the conducting element in a central segment of settable length and the processing of said image points by means of a clustering algorithm applied to the second main component.

As in the previous case relating to the clustering of the image points that relate to the same supporting element, also in this case it is possible to provide any type of clustering algorithm. Clustering algorithms are preferred for which it is not necessary to indicate in advance a number of clusters as in the previous case. Also in this case, valid examples of clustering algorithms consist of the algorithms known with the name DBSCAN, HDBSCAN or similar algorithms or combinations of these algorithms.

After step 803, step 804 provides for the count of the number of clusters generated and step 805 provides for the assignment of the image points of each separated cluster to a separate cable and provides the definition of the number of point clusters relating to conductors such as number of separate cables between the two clusters representing the two supporting elements.

FIG. 9 shows an embodiment of a workflow relating to a graph optimization procedure obtained with the above described method or with any alternative embodiments described above.

The process begins in step 900 and in step 901 the assignment to any arc of the graph of a weight inversely proportional to the length of said arc is performed. As indicated with 902, the so called “Maximum Spanning Tree” is then performed according to algorithms known to the state of the art.

Step 903 therefore provides for the elimination of arcs that form cycles that are usually generated by wrong connections in a minimum spanning tree extraction procedure.

A cycle of said procedure is made up of at least two arcs, and the choice of the arc(s) to be eliminated to interrupt the cycle, provides for the evaluation of the weight of the arc by eliminating the longest arc, assuming that it is more likely that this longer arc is an arc between two nodes indirectly connected through another node and not directly with each other.

In addition to the reduction of the number of arcs in the graph it is also possible to optimize the graph for point clusters classified as being part of a supporting element, said supporting element being however not connected to any further supporting element following the verification performed according to what is previously described as indicated in 904. These clusters and the related nodes can be optionally eliminated by the graph as indicated in step 905.

At the end of the aforementioned optimization steps that can be performed in combination with each other as indicated in FIG. 9 or also alternately with each other, i.e. only one of said two steps, the final optimized graph 906 is generated.

This can be stored as indicated in 907 or alternately or in combination, and also displayed or printed as indicated in 908.

The steps indicated with discontinue lines constitute optional steps that can be performed or not according to the needs and choices of the user.

Step 910 provides that the optimized graph is recorded with the two-dimensional geographical map of the territory projected on the same two-dimensional graph plane, and that subsequently, in step 911 said graph is overlapped to said geographical map and/or also stored or displayed or printed according to the needs as indicated with steps 912 and 913 and/or also subjected to a postprocessing or made available for a postprocessing in order to determine anomalies of the electrical grid represented by graph as indicated in step 920.

1. A method for generating two-dimensional graphical maps of overhead electrical distribution grids, which method comprises:
a) providing at least one three-dimensional image of a territory in which at least one segment of an electric distribution grid is provided, which image consists of a three-dimensional image point cloud;
b) providing at least one subgroup of the image points of the said three-dimensional image point cloud, which subgroup comprises image points classified as potentially belonging to a group of constituent elements of the said at least one electric distribution grid segment and each of these image points has been uniquely associated with a classification category of a corresponding constituent element of the said at least one electrical distribution grid segment that said image points represent;
c) projecting said image points onto a horizontal plane, defined as projecting said image points onto a two-dimensional map of the territory corresponding to the position coordinates of said image points, and
d) subdividing the said image points uniquely associated with one of the said categories of the constituent elements of the grid into sets of image points having the same classification category and representing a same constituent element, at least according to the classification category and also, at least for the points representing the said one or more supports, said subdivision being based on the relative distance between the said classified image points, defined as the relative position between the said classified image point, thereby identifying image points relating to one or more supports and image points relating to one or more conductors;
e) generating a representation of the said at least one electric grid segment by means of a graph, in which graph, the sets of image points classified as being representative of a supporting element are represented by the nodes of the said graph, and the sets of image points classified as conductors are represented by arcs linking at least two nodes together;
f) storing the said representation and printing or displaying the same,
wherein it is provided the further step of superimposing said graph on said two-dimensional territory map at a position of said nodes and conductors corresponding to the geographical position relating to said territory map calculated from the coordinates of said image points.

2. The method according to claim 1, wherein the nodes representing the individual support elements and the arcs representing the conductors can be associated with additional attributes such as the position of one or more of the support elements represented by the nodes, either the position relating to the other support elements and/or either the absolute position referring to the territory map and/or the vertices of a minimum area polygon, particularly a quadrilateral polygon which contains all the image points of the set representing the same support element and/or the attributes indicating the number of conductors that are represented by an arc linking two support elements together.

3. The method according to claim 1 comprising:
g) verifying whether or not two supporting elements are linked together, which step includes counting of image points of the set of image points classified as representative of a conductor which corresponds to an arc connecting two nodes representative of two supporting elements and comparing the number of image points of the set of said image points representative of said conductor with a predetermined minimum threshold number of image points, below which said two supporting elements are not considered to be linked together.

4. The method according to claim 1, comprising:
h) determining the number of cables linking two supporting elements together, which step comprises the use of an image point clustering algorithm of the set of image points classified as representing a conducting element along a linking arc of two nodes defined as two supporting elements, said number of clusters being defined as the number of cables.

5. The method according to claim 1, wherein steps b) to e) comprise
filtering from the three-dimensional image point cloud the image points relating to a classification category that is different from the classification category relating to the grid constituent elements or the classification category relating to the supports and conductors;
eliminating the coordinate along the vertical axis (height) of each image point, by bringing the image points onto a two-dimensional horizontal plane;
clustering the image points relative to each support element with a clustering algorithm,
calculating for each said calculated cluster of image points the centroid and determining the vertices of the minimal rectangle that contains all the image points of the said cluster,
wherein the centroid of each image point cluster defines the position of the corresponding node of the final graph and the vertices of the rectangle containing the image points of the corresponding image point cluster of the corresponding node defines a measure that is indicative of the area occupied by the corresponding support element, while
verifying for each image point cluster relating to a support element, whether it is linked to other image point clusters relating to other adjacent supports, and in the case of a positive check for the existence of the link, an arc is added in the final graph between the two adjacent nodes resulting to be linked, being settable a maximum distance from each node within which the presence of at least one additional node linked to it is to be determined, which distance is optionally settable,
wherein two nodes corresponding to two supporting elements are considered not directly linked together when between them there is an additional node that corresponds to an additional supporting element, wherein said two supporting elements are considered to be linked through said additional supporting element, and wherein there are provided arcs connecting the nodes representing said two supporting elements with the node representing said additional intermediate supporting element.

6. The method according to claim 1, wherein upstream of the linking of nodes to each other by the arcs of the graph, said nodes are ordered with the corresponding centroids and the corresponding vertices according to one of the coordinates of the two-dimensional reference plane for the graph and the two-dimensional territorial map defined as a substantially horizontal plane, preferably relative to the X coordinate of a Cartesian reference system underlying said plane.

7. The method according to claims 1, wherein after verification of the linking of a node to an additional adjacent node, defined as the image point cluster respectively corresponding to the said nodes, the method optionally provides to eliminate the nodes that do not result to be linked to additional nodes of the image point clusters classified in the category of supporting elements.

8. The method according to claim 1, wherein the additional step of extracting the maximum spanning tree of the graph is provided, wherein each arc is associated with a weight inversely proportional to its length and the arcs between two adjacent nodes are preferred to other arcs that are eliminated or considered eliminable.

9. The method according to claim 1, wherein for the verification on whether or not two image point clusters representative of two adjacent support elements are linked together or not, the following steps are provided for verifying the linking between adjacent support elements:
calculating a rotation matrix that makes horizontal the segment joining the two centroids of the image point clusters each representing one of two supporting elements;
rotating according to the rotation matrix as calculated in the previous step the image points and in particular the centroids and vertices of the clusters of said image points representing said supporting elements and further rotating the image point clusters that belong to the classification category of at least one conductor occurring among said image point clusters which represent said supporting elements,
the image points of the image point cluster that belong to the classification category of at least one conductor are filtered before and/or after said preceding steps in such a manner as to maintain only the image points which are present in a corridor defined by the vertices of the minimum rectangles relating to the image point clusters belonging to the category of support elements and relating to said two support elements,
the area defined by said corridor and between said two nodes representing said two supporting elements is subdivided into a plurality of blocks of fixed length, which length is optionally set as required and for each block and
determining the number of image points present in the corresponding block and corresponding to the classification category relating to the conductive element,
while the said number of image points determined in a block is compared with a minimum number of image points having a classification category relating to a minimum conductive element, which minimum number is settable and is considered to be occupied by a segment of a conductive element when the said number of image points determined in a corresponding block is greater than the said minimum number, and
wherein the two supporting elements relating to the said two image point clusters having a classification category relating to the considered supporting elements linked together by at least one conductive element when by a predetermined percentage higher than a certain settable threshold, the blocks of the said plurality of blocks into which the said corridor is divided are considered occupied, providing that the number of image points corresponding to at least one conductive element in the said blocks is higher than the said minimum number, while when the said percentage of the said blocks considered occupied is lower than the said settable threshold the two supporting elements are not considered to be linked together; and
providing in the first case an arc linking the two nodes that represent the said two supporting elements, while in the second case the said linking arc is not present.

10. The method according to claim 9, wherein there is further provided the step of setting a right margin and/or a left margin of said corridor, which margin delimits an area of said corridor that is intermediate between said two supporting elements, defined as the area of said corridor being positioned between the containment quadrilaterals of the related image point clusters, which margins are spaced relatively to said image point clusters to a predetermined extent so as to consider only those image points relating to at least one conducting element that are present only in said intermediate part of said corridor, without considering for the determination of the existence of the link the image points relating to the said at least one conducting element that are relatively close to the image point clusters corresponding to the supporting elements accordingly to a predetermined position of said margins with respect to the said image point clusters corresponding to the supporting elements at the poles.

11. The method according to claim 1, wherein the following steps are provided for the determination of the number of cables that link two adjacent support elements:
starting from the image points representative for at least one conductor element identified among the image point clusters relating to two supporting elements, the first and second principal components are calculated using a Principal Component Analysis algorithm (also referred to as PCA);
the first component is used to eliminate by filtering the image points adjacent to the image point clusters relating to the said supporting elements, leaving only the image points representative of the conducting element(s) present in a central segment between the two image point clusters representative of the two supporting elements and whose central segment is of settable length;
a clustering algorithm is then applied to the second principal component of the remaining image points after the aforementioned filtering step, with the number of clusters being provided by the said clustering algorithm and defined as the number of cables that link the said two supporting elements together.

12. The method according claim 1, wherein step a) of 3D images acquisition is performed using imagery systems, preferably airborne, of optical and/or photographic and/or infrared type and/or by use of the technology called LIDAR for the generation of three-dimensional point clouds and optionally by means of drones or devices called UAVs (Unmanned Aerial Vehicle) and/or by means of helicopters or other human-guided aircraft and/or by means of ground vehicles.

13. A system comprising generic image processing hardware, wherein said hardware comprises:
at least one processor,
at least one memory containing at least one image processing program,
one or more interfaces for data input to be performed by the user manually or by means of a reading device of data storage media and/or by means of transmission through a communication network of Wi-Fi or wired type,
at least one interface for printing and/or displaying data or information,
said image processing program comprising encoded instructions for enabling the processor and related generic peripherals to perform automatically or on command by a user the following steps:
providing at least one three-dimensional image of a territory in which at least one segment of an electric distribution grid is provided, which image consists of a three-dimensional image point cloud;
providing at least one subgroup of the image points of the said three-dimensional image point cloud, which subgroup comprises image points classified as potentially belonging to a group of constituent elements of the said at least one electric distribution grid segment and each of these image points has been uniquely associated with a classification category of a corresponding constituent element of the said at least one electrical distribution grid segment that said image points represent;
projecting said image points onto a horizontal plane, defined as projecting said image points onto a two-dimensional map of the territory corresponding to the position coordinates of said image points, and
subdividing the said image points uniquely associated with one of the said categories of the constituent elements of the grid into sets of image points having the same classification category and representing a same constituent element, at least according to the classification category and also, at least for the points representing the said one or more supports, said subdivision being based on the relative distance between the said classified image points, defined as the relative position between the said classified image point, thereby identifying image points relating to one or more supports and image points relating to one or more conductors;
generating a representation of the said at least one electric grid segment by means of a graph, in which graph, the sets of image points classified as being representative of a supporting element are represented by the nodes of the said graph, and the sets of image points classified as conductors are represented by arcs linking at least two nodes together;
storing the said representation and printing or displaying the same,
wherein it is provided the further step of superimposing said graph on said two-dimensional territory map at a position of said nodes and conductors corresponding to the geographical position relating to said territory map calculated from the coordinates of said image points.

14. A system according to claim 13 wherein the system consists of a kit of parts comprising in combination
at least one self-contained device for capturing three-dimensional images of a predetermined scene and at least one processor integrated into said device or separated and communicating with said device,
which processor executes a processing program of the acquired images of said scene, and
which program comprises instructions for executing an algorithm for generating an image point cloud, classifying said image points with respect to one or more diversifying features of one or more objects reproduced in said image point cloud, and filtering image points related to attributes or categories of classifications that do not correspond to one or more specific user-selectable classification attributes.

15. A computer program comprising instructions for performing one or more or all of the steps of the method of claim 1, and which program is stored on a fixed or portable storage medium t hat is readable by a generic computer provided with a corresponding reading device of said storage medium.

16. A fixed or transportable storage medium on which is stored a computer program that comprises the instructions for performing one or more or all of the following steps:
providing at least one three-dimensional image of a territory in which at least one segment of an electric distribution grid is provided, which image consists of a three-dimensional image point cloud;
providing at least one subgroup of the image points of the said three-dimensional image point cloud, which subgroup comprises image points classified as potentially belonging to a group of constituent elements of the said at least one electric distribution grid segment and each of these image points has been uniquely associated with a classification category of a corresponding constituent element of the said at least one electrical distribution grid segment that said image points represent;
projecting said image points onto a horizontal plane, defined as projecting said image points onto a two-dimensional map of the territory corresponding to the position coordinates of said image points, and
subdividing the said image points uniquely associated with one of the said categories of the constituent elements of the grid into sets of image points having the same classification category and representing a same constituent element, at least according to the classification category and also, at least for the points representing the said one or more supports, said subdivision being based on the relative distance between the said classified image points, defined as the relative position between the said classified image point, thereby identifying image points relating to one or more supports and image points relating to one or more conductors;
generating a representation of the said at least one electric grid segment by means of a graph, in which graph, the sets of image points classified as being representative of a supporting element are represented by the nodes of the said graph, and the sets of image points classified as conductors are represented by arcs linking at least two nodes together;
storing the said representation and printing or displaying the same,
wherein it is provided the further step of superimposing said graph on said two-dimensional territory map at a position of said nodes and conductors corresponding to the geographical position relating to said territory map calculated from the coordinates of said image points, that can be read by a reader or connected to a port of a system comprising:
generic image processing hardware, wherein said hardware comprises:
at least one processor,
at least one memory containing at least one image processing program,
one or more interfaces for data input to be performed by the user manually or by means of a reading device of data storage media and/or by means of transmission through a communication network of Wi-Fi or wired type,
at least one interface for printing and/or displaying data or information,
said image processing program comprising encoded instructions for enabling the processor and related generic peripherals to perform the steps automatically or on command by a user.
